(19) United States
(12) Patent Application Publication
(10) Pub. No.: US 2025/0309593 A1
(43) Pub. Date: Oct. 2, 2025

(54) CONNECTOR ASSEMBLY COMPRISING COAXIAL CONNECTOR

(71) Applicant: JAPAN AVIATION ELECTRONICS INDUSTRY, LIMITED, Tokyo (JP)

(72) Inventor: Keisuke NAKAMURA, Tokyo (JP)

(73) Assignee: JAPAN AVIATION ELECTRONICS INDUSTRY, LIMITED, Tokyo (JP)

(21) Appl. No.: 19/058,018

(22) Filed: Feb. 20, 2025

(30) Foreign Application Priority Data
Mar. 28, 2024 (JP) 2024-054491

(51) Int. Cl. H01R 24/50; H01R 103/00

(52) U.S. Cl. CPC H01R 24/50; H01R 2103/00

(57) ABSTRACT

A connector assembly comprises a coaxial connector and a plate which has an upper surface formed with a sloping portion. The coaxial connector comprises an outer terminal and a center terminal. The outer terminal has an end surface and a projecting portion which projects forward from the end surface and has a pressing portion. The center terminal has a contact portion. Under a pre-connected state where the coaxial connector is not yet connected to a board, at least a part of the contact portion is located forward of the end surface and is located below the pressing portion. Under a connected state where the coaxial connector is connected to the board, the pressing portion presses an upper surface of the board from above, and at least a part of the contact portion is pressed against a signal line of the board to be in contact with the signal line.

### CROSS REFERENCE TO RELATED APPLICATIONS

This application is based on and claims priority under 35 U.S.C. § 119 to Japanese Patent Application No. JP 2024-054491 filed Mar. 28, 2024, the content of which is incorporated herein in its entirety by reference.

### BACKGROUND OF THE INVENTION

This invention relates to a coaxial connector configured to be connected to a board.

For example, this type of coaxial connector is disclosed in JP2009-064588A (Patent Document 1), the content of which is incorporated herein by reference.

Referring to FIG. 11, Patent Document 1 discloses a coaxial connector 90 fixed to a case 94. The case 94 is provided with a board 96 located therein. The board 96 is formed with a transmission line (signal line) 98. The coaxial connector 90 comprises a terminal portion (center terminal) 92. The center terminal 92 is electrically connected with the signal line 98 of the circuit board 96. The electrical connection as described above is usually performed by soldering the center terminal 92 to the signal line 98.

There is a demand for electrically connecting the coaxial connector with a board without soldering.

### SUMMARY OF THE INVENTION

It is therefore an object of the present invention to provide a coaxial connector configured to be connected to a board by a new method other than the soldering.

An aspect of the present invention provides a connector assembly comprising a coaxial connector configured to be connected to a board, a plate and a fixing member. The board extends along a horizontal plane and has an upper surface in an up-down direction perpendicular to the horizontal plane, the upper surface is formed with a signal line, and the signal line extends in a front-rear direction perpendicular to the up-down direction. The coaxial connector comprises an outer terminal, a center terminal and an insulation member. The insulation member insulates the outer terminal and the center terminal from each other. The outer terminal has a projecting portion and an end surface. The projecting portion projects forward from the end surface and has a pressing portion. The pressing portion is located at a lower end of the projecting portion. The center terminal has a contact portion. The plate has a sloping portion. The sloping portion is formed on an upper surface of the plate. The sloping portion extends toward a rear end of the plate while sloping downward. Under a pre-connected state where the coaxial connector is not yet connected to the board, at least a part of the contact portion is located forward of the end surface and is located below the pressing portion. Under a connected state where the coaxial connector is fixed and connected to the board, the fixing member fixes the projecting portion and the plate to each other so that the board is sandwiched and held between the projecting portion and the plate in the up-down direction. Under the connected state, a front end of the contact portion is located above the sloping portion of the plate and is located at a position which is not beyond a front end of the sloping portion in the front-rear direction, the pressing portion presses the upper surface of the board from above, and at least a part of the contact portion is pressed against the signal line of the board to be in contact with the signal line.

According to an aspect of the present invention, the contact portion of the center terminal under the pre-connected state is located below the pressing portion of the projecting portion. The front end of the contact portion under the connected state is located above the sloping portion of the plate. According to this arrangement, under the connected state, the upper surface of the board is pressed by the pressing portion from above, and the contact portion is pressed against the signal line to be in contact with the signal line while being resiliently deformed so as to extend along the sloping portion. Thus, an aspect of the invention provides a coaxial connector configured to be connected to a board by a new method other than the soldering.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is an exploded, perspective view showing a structure according to an embodiment of the present invention, wherein a connector assembly of the structure is under a pre-connected state where its coaxial connector is not yet connected to a board, and an outline of a coaxial cable is schematically illustrated with dashed line.

FIG. 2 is a front view showing the coaxial connector of the connector assembly of FIG. 1, wherein outlines of hidden screw holes are illustrated with dashed line.

FIG. 3 is a cross-sectional view showing the coaxial connector of FIG. 2, taken along line III-III, wherein an outline of the coaxial cable is schematically illustrated with dashed line.

FIG. 4 is a cross-sectional view showing a part of the coaxial connector enclosed by two-dot chain line A of FIG. 3.

FIG. 5 is a perspective view showing the structure of FIG. 1, wherein the connector assembly of the structure is under a connected state where the coaxial connector is connected to the board, and an outline of the coaxial cable is schematically illustrated with dashed line.

FIG. 6 is a top view showing the structure of FIG. 5, wherein an outline of a hidden contact portion of a center terminal is partially illustrated with dashed line.

FIG. 7 is a side view showing the structure of FIG. 5.

FIG. 8 is a front view showing the structure of FIG. 5, wherein outlines of hidden screw holes, hidden fixing holes and hidden passing holes are illustrated with dashed line.

FIG. 9 is a cross-sectional view showing the structure of FIG. 8, taken along line IX-IX, wherein cross-sections of the coaxial cable and a mating connector are schematically illustrated with dashed line.

FIG. 10 is a cross-sectional view showing a part of the structure enclosed by two-dot chain line B of FIG. 9, wherein an outline of the contact portion of the center terminal under the pre-connected state is illustrated with dashed line.

FIG. 11 is a perspective view showing a coaxial connector, a case and a board of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

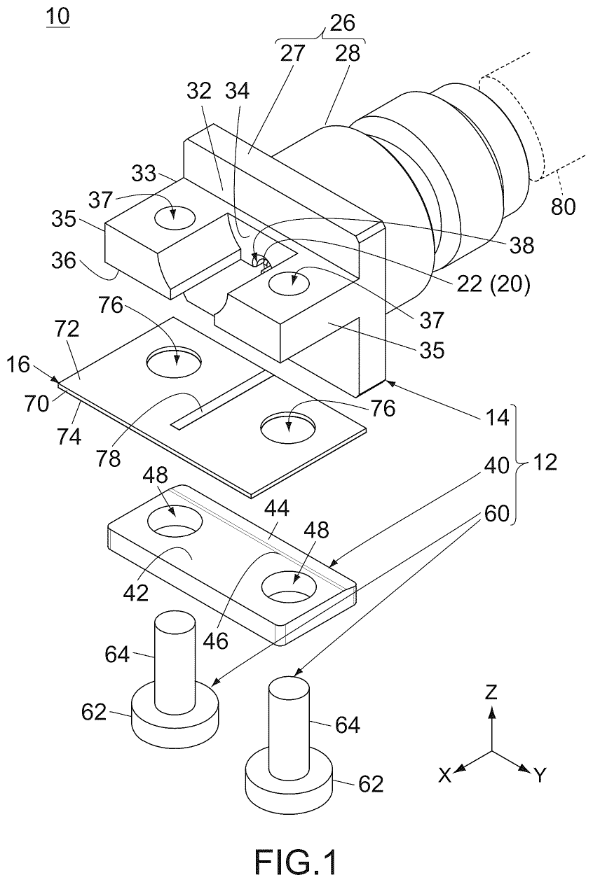

As shown in FIG. 1, a structure 10 according to an embodiment of the present invention comprises a connector assembly 12 and a board 16. The structure 10 of the present embodiment is an antenna structure. However, the present invention is not limited thereto but is applicable to various structures. The structure 10 may further comprise another member in addition to the aforementioned members.

The connector assembly 12 of the present embodiment comprises a coaxial connector 14, a plate 40 made of metal and two fixing members (screws) 60 each made of metal. However, the present invention is not limited thereto. For example, the connector assembly 12 may further comprise another member in addition to the aforementioned members. Each of the plate 40 and the fixing members 60 may be a part of a single member in which the plate 40 and the fixing members 60 are formed integrally with each other.

Referring to FIG. 1 together with FIG. 5, the board 16 of the present embodiment extends along a horizontal plane. The coaxial connector 14 is configured to be connected to the board 16. In detail, the coaxial connector 14 is configured to be connected to a rear end of the board 16 in a front-rear direction in parallel to the horizontal plane.

The horizontal plane of the present embodiment is the XY-plane. The front-rear direction of the present embodiment is the X-direction. In the present embodiment, “forward” means the positive X-direction, and “rearward” means the negative X-direction. The words such as the horizontal plane and the front-rear direction do not indicate the absolute positional relation relative to the ground but merely indicate a relative positional relation under a definition where the board 16 extends in the horizontal plane when not bent at all, and where the connector assembly 12 is located forward of this board 16.

Hereafter, explanation will be made about the board 16 of the present embodiment.

Referring to FIG. 1, the board 16 of the present embodiment is a flexible board and comprises a base 70 which is formed of a thin film-like insulator. The board 16 of the present embodiment comprises only the base 70 except for various conductive patterns formed on the base 70. The thus-formed board 16 is easily bent and can be flexibly arranged in a narrow space in an apparatus (not shown). However, the present invention is not limited thereto. For example, the board 16 may be provided with electronic components in addition to the base 70 and the conductive patterns.

The board 16 has an upper surface 72 and a lower surface 74 in an up-down direction perpendicular to the horizontal plane. The upper surface 72 and the lower surface 74 are located at an upper end and a lower end of the base 70, respectively. The up-down direction of the present embodiment is the Z-direction. In the present embodiment, “upward” means the positive Z-direction, and “downward” means the negative Z-direction.

The board 16 is formed with two passing holes 76. Each of the passing holes 76 passes through the board 16 in the up-down direction. Each of the passing holes 76 has a circular shape in the horizontal plane. The thus-formed passing holes 76 are used when the coaxial connector 14 is screwed to the board 16 as described later. The two passing holes 76 are apart from each other in a lateral direction perpendicular to both the front-rear direction and the up-down direction and are located at positions same as each other in the front-rear direction. The lateral direction of the present embodiment is the Y-direction.

The passing holes 76 of the present embodiment are formed as described above. However, the present invention is not limited thereto. For example, the shape of each of the passing holes 76 is not specifically limited. The number of the passing holes 76 may be one, three or more. In an instance in which the number of the passing holes 76 is three or more, two of the passing holes 76 may be apart from each other in the lateral direction and may be located at positions same as each other in the front-rear direction.

The upper surface 72 of the board 16 is formed with a signal line 78 which is a conductive pattern. The signal line 78 extends in the front-rear direction perpendicular to the up-down direction and is located between the two passing holes 76 in the lateral direction. The lower surface 74 of the board 16 is formed with a ground layer (not shown) which is another conductive pattern and covers the whole of the lower surface 74.

The signal line 78 is connected to an antenna which is formed on an unillustrated front end part of the board 16, for example. The coaxial connector 14 connected to the board 16 transmits signals to the antenna through the signal line 78. The thus-transmitted signals are sent outward from the antenna. On the other hand, signals received by the antenna are transmitted to the coaxial connector 14 through the signal line 78. The structure 10 of the present embodiment is uses as described above, for example. However, the usage of the structure 10 of the present invention is not specifically limited. The structure 10 of the present invention may be any electric device with the board 16.

The board 16 of the present embodiment has the aforementioned configuration. However, the configuration of the board 16 can be modified in accordance with the usage of the structure 10. For example, the ground layer (not shown) may be partially formed on the lower surface 74.

Hereafter, explanation will be made about the coaxial connector 14 of the present embodiment.

Referring to FIGS. 1 and 5, the coaxial connector 14 of the present embodiment is a so-called sub miniature type A (SMA) connector. However, the present invention is not only applicable to an SMA connector but also applicable to various coaxial connectors.

The coaxial connector 14 is configured to be attached to the coaxial cable 80 and to be connected to the board 16. The coaxial connector 14 of FIG. 5 is under a connected state where the coaxial connector 14 is fixed and connected to the board 16. The coaxial connector 14 of FIG. 1 is under a pre-connected state where the coaxial connector 14 is not yet connected to the board 16.

Referring to FIG. 3 together with FIG. 9, the coaxial cable 80 illustrated with dashed line in FIGS. 3 and 9 is a typical coaxial cable and comprises a core wire 84 made of conductor, an inner insulator 85 made of insulator and covering the core wire 84, a shield 86 made of conductor and covering the inner insulator 85 and a sheath 87 made of insulator and covering the shield 86. The number of the core wire 84 of the present embodiment is one. However, the configuration of the coaxial cable 80 of the present invention is not specifically limited.

The coaxial cable 80 is configured to be attached to a rear end of the coaxial connector 14. According to the present embodiment, the coaxial cable 80 is configured to be attached to the rear end of the coaxial connector 14 via a mating connector 89 attached to the coaxial cable 80. However, the present invention is not limited thereto. For example, the coaxial cable 80 may be configured to be directly attached to the rear end of the coaxial connector 14.

Referring to FIG. 3 together with FIG. 1, the coaxial connector 14 of the present embodiment comprises a center terminal 20 made of conductor, an insulation member 25 made of insulator and an outer terminal 26 made of conductor. The coaxial connector 14 of the present embodiment comprises only the aforementioned members. However, the present invention is not limited thereto. For example, the coaxial connector 14 may further comprise another member in addition to the aforementioned members.

The outer terminal 26 of the present embodiment comprises a front conductive member 27 and a rear conductive member 28. The front conductive member 27 is combined with the rear conductive member 28 and is located forward of the rear conductive member 28. The front conductive member 27 is in contact with the rear conductive member 28. The outer terminal 26 of the present embodiment consists of the aforementioned two members. However, the present invention is not limited thereto, but the configuration of the outer terminal 26 can be variously modified. For example, the front conductive member 27 and the rear conductive member 28 may be members formed integrally with each other. The outer terminal 26 may further comprise another member in addition to the front conductive member 27 and the rear conductive member 28.

As shown in FIGS. 3 and 9, the outer terminal 26 is formed with a receiving portion 39. The receiving portion 39 of the present embodiment is a space which is formed in the rear conductive member 28. The receiving portion 39 extends along the front-rear direction and opens rearward. According to the present embodiment, the mating connector 89 attached to the coaxial cable 80 is fit into the receiving portion 39 along the front-rear direction, and thereby the coaxial cable 80 is indirectly received in the receiving portion 39 via the mating connector 89. However, the present invention is not limited thereto. For example, the coaxial cable 80 may be directly received in the receiving portion 39.

The rear conductive member 28 of the outer terminal 26 is electrically connected with the shield 86 of the coaxial cable 80 when the coaxial cable 80 is received in the receiving portion 39. The outer terminal 26 and the shield 86 connected to each other have ground potentials same as each other.

The center terminal 20 of the present embodiment extends straight along the front-rear direction under the pre-connected state. The center terminal 20 has a body 21, a contact portion 22 and a connection portion 23. The body 21, the contact portion 22 and the connection portion 23 of the present embodiment are formed integrally with each other. In other words, each of the body 21, the contact portion 22 and the connection portion 23 is a part of the single center terminal 20.

The body 21 is located at the middle of the center terminal 20 in the front-rear direction. The connection portion 23 has a socket shape. The body 21 extends from the connection portion 23 to the contact portion 22 straight along the front-rear direction. The contact portion 22 extends forward from the body 21. The center terminal 20 of the present embodiment has the aforementioned portions. However, the present invention is not limited thereto. For example, the center terminal 20 may be formed of two members which are formed separately from each other and then connected to each other. The center terminal 20 may further have another portion in addition to the aforementioned portions.

The body 21 of the present embodiment has a circular shape in a vertical plane (YZ-plane) perpendicular to the front-rear direction. The contact portion 22 is resiliently deformable. In detail, the contact portion 22 of the present embodiment has a circular shape which is smaller than that of a rear part of the body 21 in the YZ-plane and is resiliently deformed easily by any force along the YZ-plane. The center terminal 20 of the present embodiment has the aforementioned shape. However, the present invention is not limited thereto. For example, the shape of the contact portion 22 in the YZ-plane may be elliptical or polygonal.

The connection portion 23 is configured to be connected to the coaxial cable 80. In detail, the connection portion 23 is electrically connected with the core wire 84 of the coaxial cable 80 when the coaxial cable 80 is received in the receiving portion 39. The connection portion 23 may be indirectly connected to the core wire 84 via a pin terminal of the mating connector 89. Instead, the connection portion 23 may be directly connected to the core wire 84. The center terminal 20 and the core wire 84 connected to each other transmit signals to each other.

The insulation member 25 of the present embodiment encloses the body 21 of the center terminal 20 in the YZ-plane. The outer terminal 26 encloses the connection portion 23 in the YZ-plane with a distance formed therebetween. The outer terminal 26 also encloses the body 21 with the insulation member 25 located therebetween in the YZ-plane. The thus-arranged insulation member 25 is located between the center terminal 20 and the outer terminal 26 in the YZ-plane and insulates the outer terminal 26 and the center terminal 20 from each other.

The center terminal 20 of the present embodiment is covered by the insulation member 25 as described above. The center terminal 20 and the insulation member 25 extend straight along the front-rear direction. The front conductive member 27 is formed with an attachment hole 272. Thus, the outer terminal 26 of the present embodiment is formed with the attachment hole 272.

The attachment hole 272 extends along the front-rear direction as a whole and opens forward and rearward of the front conductive member 27. According to this configuration, the coaxial connector 14 can be fabricated as described below. Firstly, the center terminal 20 and the rear conductive member 28 are connected to the coaxial cable 80. Then, the center terminal 20 and the insulation member 25 are inserted into the attachment hole 272 along the front-rear direction. The thus-inserted center terminal 20 is received and attached in the attachment hole 272 so as to extend along the front-rear direction.

According to the aforementioned fabrication method, the coaxial connector 14 can be easily fabricated. The center terminal 20 and the insulation member 25 have a point symmetrical shape in the YZ-plane, and this shape enables easy fabrication of the coaxial connector 14. However, the configuration of the center terminal 20 can be modified as necessary.

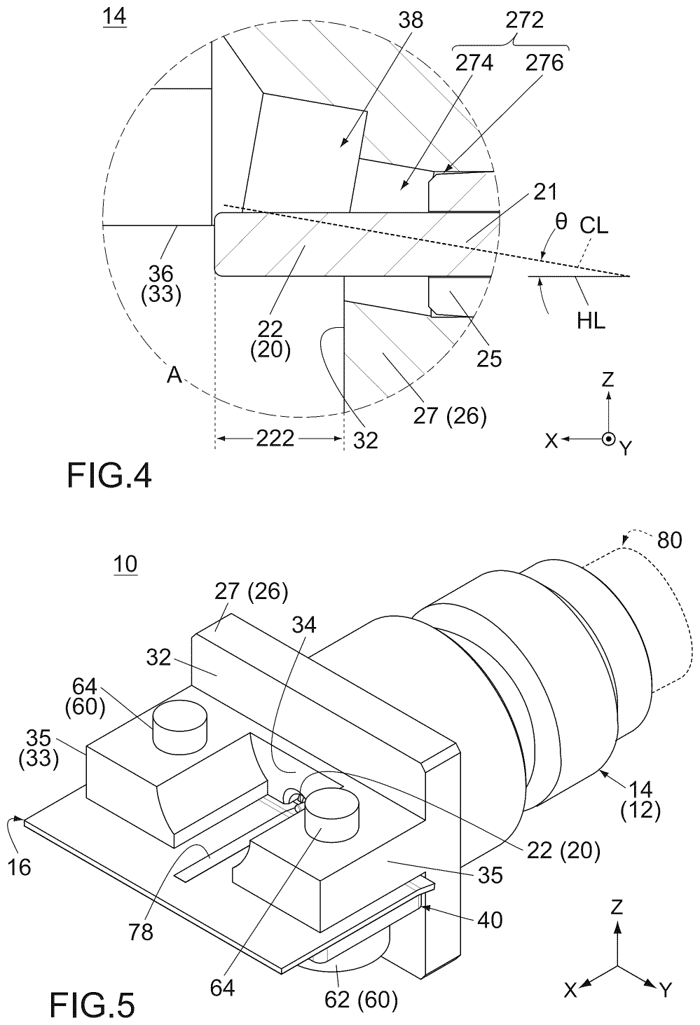

Referring to FIGS. 3 and 4, the attachment hole 272 of the present embodiment has a front hole 274 and a rear hole 276. The rear hole 276 extends along the front-rear direction and opens rearward of the front conductive member 27. The rear hole 276 is completely enclosed by the front conductive member 27 of the outer terminal 26 in the YZ-plane. The front hole 274 extends forward and upward from a front end of the rear hole 276 and opens forward of the front conductive member 27. In detail, the front hole 274 has a cylindrical shape about an imaginary center line CL oblique to the front-rear direction. The front hole 274 is completely enclosed by the front conductive member 27 of the outer terminal 26 in a predetermined plane perpendicular to the center line CL.

The center line CL intersects with a horizontal line HL extending in parallel to the front-rear direction by an intersection angle θ. The intersection angle θ of the present embodiment is about ten degrees. However, the intersection angle θ of the present invention is not specifically limited. For example, the intersection angle θ may be five degrees or more.

The center terminal 20, the insulation member 25 and the outer terminal 26 of the present embodiment are arrange as described above. According to the present embodiment, the body 21 is a part of the center terminal 20 covered by the insulation member 25, and each of the contact portion 22 and the connection portion 23 is another part of the center terminal 20 exposed from the insulation member 25. However, the configuration and the arrangement of the center terminal 20, the insulation member 25 and the outer terminal 26 of the present invention are not specifically limited.

As shown in FIGS. 1 to 3, the outer terminal 26 has a projecting portion 33 and an end surface 32. The end surface 32 of the present embodiment is a front surface of the front conductive member 27 and a rectangular flat surface in parallel to the YZ-plane. The projecting portion 33 is located at the middle of the end surface 32 in the up-down direction and extends over all the end surface 32 in the lateral direction.

The projecting portion 33 projects forward from the end surface 32. In detail, the projecting portion 33 of the present embodiment has a middle projecting portion 34 and two side projecting portions 35. The middle projecting portion 34 is located at the middle of the projecting portion 33 in the lateral direction and projects forward from the end surface 32. The two side projecting portions 35 are located at opposite sides of the middle projecting portion 34 in the lateral direction, respectively. Each of the side projecting portions 35 projects forward from an end of the projecting portion 33 in the lateral direction beyond a front end of the middle projecting portion 34. The thus-arranged two side projecting portions 35 are apart from each other in the lateral direction and project forward from the end surface 32.

The projecting portion 33 of the present embodiment has the aforementioned configuration. However, the present invention is not limited thereto, but the configuration of the projecting portion 33 can be variously modified. For example, each of the middle projecting portion 34 and the side projecting portions 35 may be provided as necessary.

The two side projecting portions 35 of the present embodiment have a mirror symmetric shape with respect to a perpendicular plane (XZ-plane). The thus-arranged two side projecting portions 35 are located at positions same as each other in the up-down direction. Each of the side projecting portions 35 has a flat-plate shape in parallel to the horizontal plane and has an upper surface and a lower surface each of which is in parallel to the horizontal plane. The number of the side projecting portions 35 of the present embodiment is two. However, the present invention is not limited thereto. For example, the number of the side projecting portions 35 may be one, three or more.

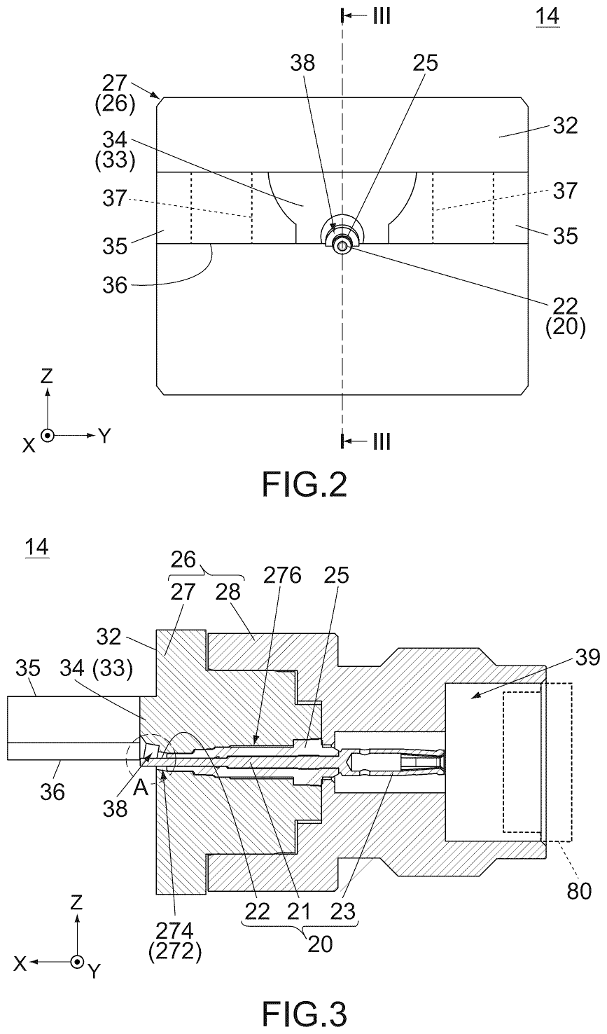

Referring to FIGS. 1 and 2, the projecting portion 33 of the present embodiment is formed with two screw holes 37. In the present embodiment, the two screw holes 37 are formed in the side projecting portions 35, respectively. Each of the screw holes 37 of the present embodiment passes through the side projecting portion 35 in the up-down direction. The screw holes 37 are provided at positions which correspond to those of the passing holes 76 of the board 16 in the horizontal plane, respectively. The thus-arranged two screw holes 37 are apart from each other in the lateral direction and are located at positions same as each other in the front-rear direction. The number of the screw holes 37 of the present embodiment is two. However, the present invention is not limited thereto. For example, in an instance in which the number of the side projecting portions 35 is one, the number of the screw holes 37 may be one. In another instance in which the number of the side projecting portions 35 is three or more, the number of the screw holes 37 may be three or more. Each of the screw holes 37 may be a hole with a ceiling.

The projecting portion 33 has a pressing portion 36. The pressing portion 36 is located at a lower end of the projecting portion 33. The pressing portion 36 of the present embodiment is a flat surface in parallel to the horizontal plane which includes lower surfaces of the two side projecting portions 35.

Referring to FIGS. 1 to 3, the outer terminal 26 of the present embodiment is formed with a center hole 38. The center hole 38 is a hole which is formed in a lower end of the middle projecting portion 34. The center hole 38 is located at the middle of the middle projecting portion 34 in the lateral direction and has a half-circular shape in the YZ-plane. The thus-formed center hole 38 is recessed upward from the lower end of the middle projecting portion 34 and opens downward. Referring to FIGS. 3 and 4, the center hole 38 extends forward and upward from a front end of the front hole 274 and opens forward. In detail, the center hole 38 has a half cylindrical shape about the center line CL.

Referring to FIGS. 1 to 3, the two side projecting portions 35 are located at opposite sides of the end surface 32, respectively, with the center hole 38 located therebetween in the lateral direction. The contact portion 22 of the center terminal 20 of the present embodiment does not extends beyond the center hole 38 but extends to a front end of the center hole 38. However, the present invention is not limited thereto. For example, the center terminal 20 may extend forward beyond the front end of the center hole 38 through the center hole 38.

Referring to FIG. 4, the contact portion 22 has a front contact portion 222. The front contact portion 222 is located forward of the end surface 32 under the pre-connected state. In other words, the front contact portion 222 is a front part of the contact portion 22 which is located forward of the end surface 32 under the pre-connected state.

The end surface 32, the pressing portion 36 and the contact portion 22 of the present embodiment are arranged as described below. Under the pre-connected state, the front contact portion 222 is located below the pressing portion 36. Thus, according to the present embodiment, a front end of the contact portion 22 under the pre-connected state is located forward of the end surface 32 and is located below the pressing portion 36. However, the present invention is not limited thereto. For example, under the pre-connected state, the whole of the contact portion 22 may be located forward of the end surface 32 and may be located below the pressing portion 36. Thus, under the pre-connected state, at least a part of the contact portion 22 may be located forward of the end surface 32 and may be located below the pressing portion 36.

Hereafter, explanation will be made about the plate 40 (see FIG. 1) and the fixing members 60 (see FIG. 1) in this order.

As shown in FIG. 1, the plate 40 of the present embodiment has a rectangular flat-plate shape in parallel to the horizontal plane. In the horizontal plane, the plate 40 has two long sides each extending in the lateral direction and two short sides each extending in the front-rear direction. The plate 40 has an upper surface and a lower surface. The lower surface of the plate 40 is a flat surface in parallel to the horizontal plane.

The plate 40 has a pressed portion 42 and a sloping portion 44. As described later, the pressed portion 42 is a part which is configured to be pressed against the board 16 under the connected state (see FIG. 9), and the sloping portion 44 is a part which enables resilient deformation of the contact portion 22 of the center terminal 20 under the connected state. According to the present embodiment, a front part of the upper surface of the plate 40 works as the pressed portion 42, and a rear part of the upper surface of the plate 40 works as the sloping portion 44. Thus, each of the pressed portion 42 and the sloping portion 44 is formed on the upper surface of the plate 40.

The pressed portion 42 is a flat surface in parallel to the horizontal plane. The sloping portion 44 is a flat surface which is oblique to the up-down direction and is in parallel to the lateral direction. The pressed portion 42 is located forward of a front end 46 of the sloping portion 44. The sloping portion 44 extends from a rear end of the pressed portion 42, which is the front end 46, toward a rear end of the plate 40 while sloping downward. Referring to FIG. 1 together with FIG. 4, the sloping portion 44 is preferred to be designed so that the sloping portion 44 inclines relative to the horizontal line HL by an inclination angle which is equal to the intersection angle θ.

Referring to FIG. 1, the plate 40 of the present embodiment is formed with two fixing holes 48. Each of the fixing holes 48 passes through the plate 40 in the up-down direction. Each of the fixing holes 48 has a circular shape in the horizontal plane. The fixing holes 48 are provided at positions which correspond to those of the passing holes 76 of the board 16 in the horizontal plane, respectively. The thus-arranged two fixing holes 48 are apart from each other in the lateral direction and are located at positions same as each other in the front-rear direction.

The plate 40 of the present embodiment has the aforementioned configuration. However, the present invention is not limited thereto. For example, the shape of each of the fixing holes 48 is not specifically limited. The number of the fixing holes 48 may be one, three or more.

The two fixing members 60 of the present embodiment have shapes same as each other. More specifically, each of the fixing members 60 of the present embodiment is a screw 60. Accordingly, each of the fixing members 60 has a head 62 and a threaded shank 64 formed with a thread (not shown). The fixing members 60 are provided so that they correspond to the passing holes 76 of the board 16, respectively. Accordingly, the number of the fixing members 60 of the present embodiment is two. However, the present invention is not limited thereto. For example, the number of the fixing members 60 may be one. The connector assembly 12 may comprise three or more of the fixing members 60 which have shapes different from each other.

Referring to FIG. 1 together with FIG. 5, the coaxial connector 14 of the present embodiment is configured to be connected to the board 16 by a connection method described below. The connection method described below is merely an example and can be modified as necessary.

Firstly, the projecting portion 33 of the coaxial connector 14, the board 16 and the plate 40 are arranged from top to bottom in this order while the screw holes 37 of the coaxial connector 14, the passing holes 76 of the board 16 and the fixing holes 48 of the plate 40 are arranged at positions same as each other in the horizontal plane. Then, each of the fixing members 60 is screwed into the screw hole 37 through the fixing hole 48 and the passing hole 76.

Referring to FIGS. 5, 7 and 8, as a result of the aforementioned screwing, the board 16 is sandwiched and held between the projecting portion 33 of the coaxial connector 14 and the plate 40 in the up-down direction. The projecting portion 33 is pressed against the board 16 from above, and the plate 40 is pressed against the board 16 from below. The thus-arranged coaxial connector 14 is under the connected state as shown in FIGS. 5 to 10. Under the connected state, the fixing members 60 fix the projecting portion 33 and the plate 40 to each other so that the board 16 is sandwiched and held between the projecting portion 33 and the plate 40 in the up-down direction.

Referring to FIG. 9, the plate 40 is located below the board 16 under the connected state. Under the connected state, the head 62 of each of the fixing members 60 is pressed against the lower surface of the plate 40 which is in parallel to the horizontal plane and presses the plate 40 upward. The pressed portion 42 of the thus-pressed plate 40, which is in parallel to the horizontal plane, presses the board 16 against the pressing portion 36 of the projecting portion 33 which is in parallel to the horizontal plane. As a result, even though the board 16 is an easily bendable flexible board, the board 16 is sandwiched and held between the projecting portion 33 and the plate 40 while keeping its posture in which the board 16 extends in parallel to the horizontal plane.

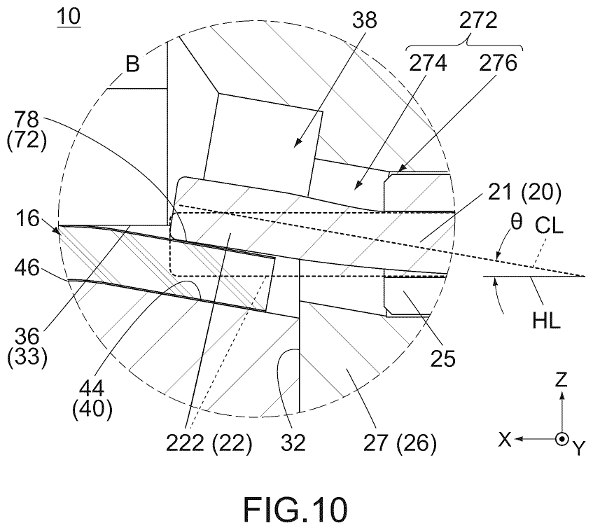

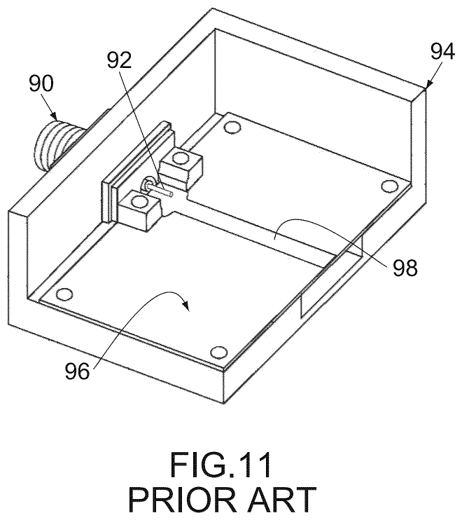

Referring to FIG. 10, the front contact portion 222, or a part of the contact portion 22 of the center terminal 20 which extends forward beyond the end surface 32, has a size in the front-rear direction smaller than that of the sloping portion 44 of the plate 40 in the front-rear direction. Under the connected state, the rear end of the plate 40 is in abutment with the end surface 32 of the outer terminal 26. According to the aforementioned arrangement, under the connected state, the front end of the contact portion 22 is located above the sloping portion 44 of the plate 40 and is located at a position which is not beyond the front end 46 of the sloping portion 44 in the front-rear direction.

According to the aforementioned arrangement, a part of the contact portion 22 which is located in the vicinity of the front end of the contact portion 22 is pressed against the sloping portion 44 of the plate 40 via the board 16 under the connected state. As a result, the front contact portion 222 is resiliently deformed so as to extend along the sloping portion 44 while pressing the board 16 against the sloping portion 44.

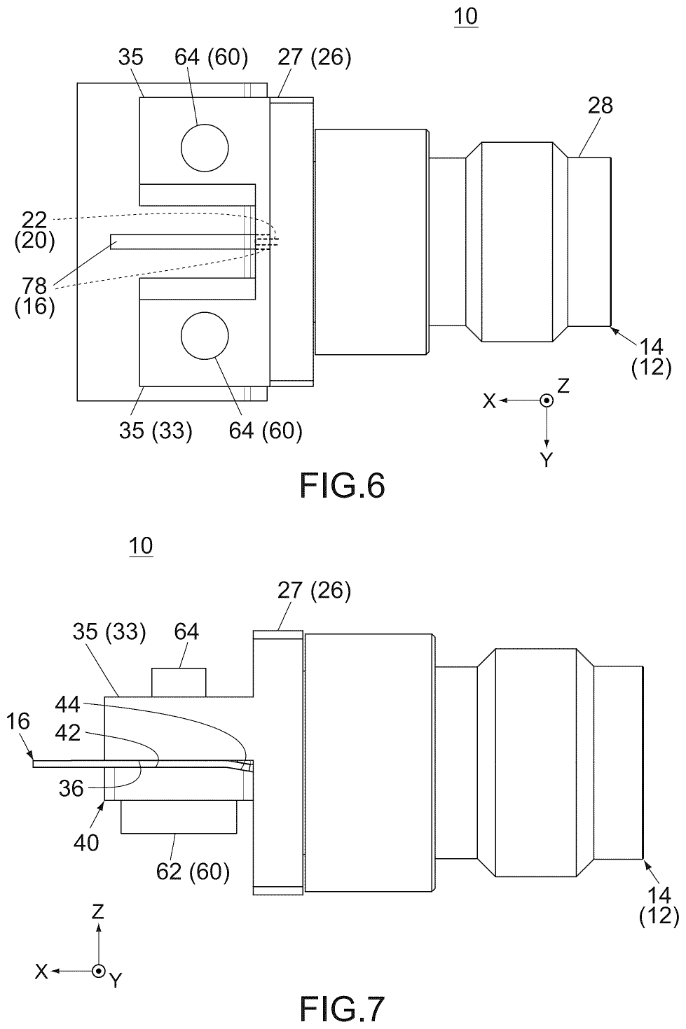

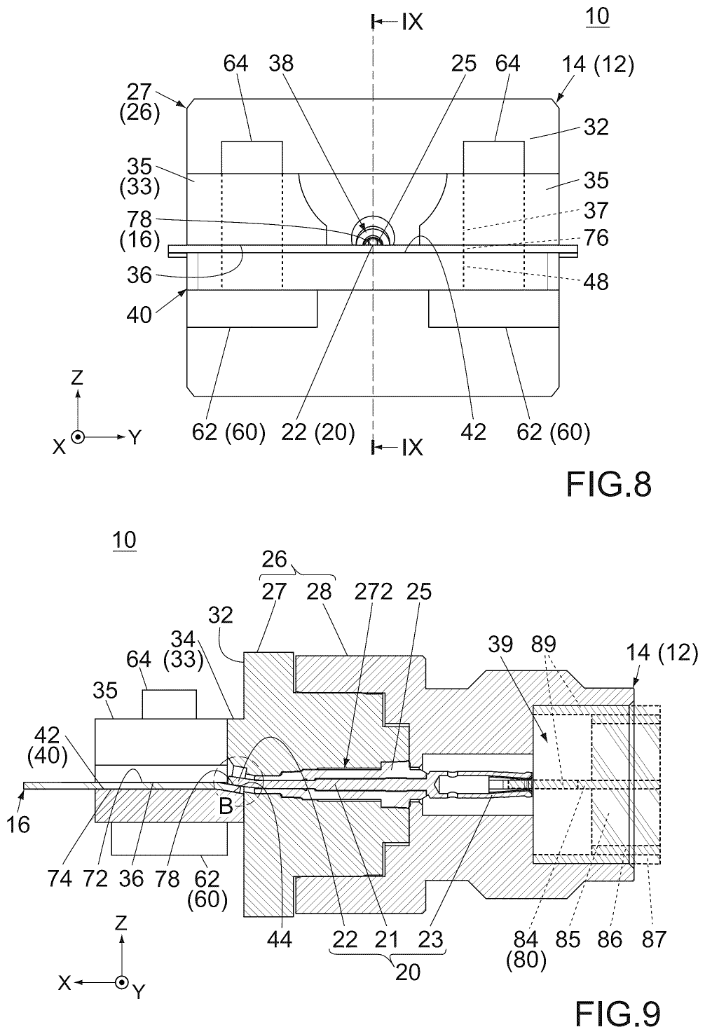

Referring to FIGS. 6 and 8, the contact portion 22 is located just over the signal line 78 of the board 16 under the connected state. Referring to FIG. 10, under the connected state, the pressing portion 36 presses the upper surface 72 of the board 16 from above, and the front contact portion 222 of the contact portion 22 is pressed against and is brought into contact with the signal line 78 of the board 16. According to the present embodiment, only a part of the contact portion 22 located in the vicinity of the front end of the contact portion 22 is pressed against the signal line 78 to be in contact with the signal line 78 under the connected state. However, the present invention is not limited thereto. For example, the whole of the contact portion 22 may be pressed against the signal line 78 to be in contact with the signal line 78. Thus, under the connected state, at least a part of the contact portion 22 may be pressed against the signal line 78 to be in contact with the signal line 78.

Summarizing the explanation described above, according to the present embodiment, the contact portion 22 of the center terminal 20 under the pre-connected state (see FIG. 4) is located below the pressing portion 36 of the projecting portion 33. The front end of the contact portion 22 under the connected state (see FIG. 10) is located above the sloping portion 44 of the plate 40. According to this arrangement, under the connected state, the upper surface 72 of the board 16 is pressed by the pressing portion 36 from above, and the contact portion 22 is resiliently deformed so as to extend along the sloping portion 44. Meanwhile, a rear end portion of the board 16 is pressed by the thus-resiliently deformed contact portion 22 to extend along the sloping portion 44. The contact portion 22 is pressed against the signal line 78 from above by a restoring force caused by the resilient deformation to be securely in contact with the signal line 78. Thus, the present embodiment provides the coaxial connector 14 configured to be connected to the board 16 by a new method other than the soldering. The coaxial connector 14 can be reliably connected with the board 16 without soldering.

Referring to FIG. 8, according to the present embodiment, the two side projecting portions 35 are fixed to the board 16 under the connected state. The contact portion 22 is located between the two side projecting portions 35 in the lateral direction. According to this arrangement, the contact portion 22 is stably in contact with the signal line 78. However, the present invention is not limited thereto. For example, the coaxial connector 14 may be provided only one of the side projecting portions 35 which is formed with the screw hole 37. In this instance, the side projecting portion 35 may be located in the vicinity of the contact portion 22 in the lateral direction. In this instance, the board 16 may be formed with only one of the passing holes 76, and the plate 40 may be formed with only one of the fixing holes 48.

According to the present embodiment, under the connected state, the projecting portion 33 and the board 16 are fixed to each other with the screws 60 each of which is screwed into the screw hole 37 of the projecting portion 33 through the fixing hole 48 of the plate 40 and the passing hole 76 of the board 16. Thus, according to the present embodiment, the plate 40 is pressed against the board 16 by screwing the fixing members 60, or the screws 60, into the side projecting portions 35. According to this connection method, the pressed portion 42 can be easily and stably pressed against the board 16. In addition, the contact portion 22 of the center terminal 20 can be resiliently deformed easily.

According to the aforementioned connection method, contact reliability between the center terminal 20 and the signal line 78 can be further improved. Moreover, the coaxial connector 14 and the plate 40 can be detached from the board 16 by merely removing the screws 60. However, the present invention is not limited thereto, but the connection method of the connector assembly 12 to the board 16 can be variously modified as described below.

Each of the side projecting portions 35 may be formed with none of the screw holes 37 while having the pressing portion 36. In this instance, the coaxial connector 14 may have two fixed portions in addition to the side projecting portions 35. Each of the fixed portions may be provided with none of the pressing portion 36 while being formed with the screw hole 37.

Each of the fixing members 60 does not need to be the screw 60. For example, each of the fixing members 60 may be a press-fit portion provided on the plate 40. Thus, each of the fixing members 60 may be a part of the plate 40. In this instance, each of the press-fit portions may extends upward from the pressed portion 42 of the plate 40. The projecting portion 33 of the coaxial connector 14 may be formed with press-fit holes instead of the screw holes 37. Each of the press-fit portions may be press-fit into the press-fit hole through the passing hole 76.

Referring to FIG. 9, the outer terminal 26 is grounded to the ground layer (not shown) of the lower surface 74 of the board 16 via the projecting portion 33, the fixing members 60 and the plate 40 under the connected state. However, the present invention is not limited thereto, but the grounding method of the outer terminal 26 to the ground layer can be modified as necessary. For example, the plate 40 may be provided with an abutment portion which is located at a rear end of the plate 40 and is configured to be reliably brought into abutment with the end surface 32 of the outer terminal 26.

Referring to FIG. 10, the insulation member 25 of the present embodiment does not extend beyond a rear end of the front hole 274. Therefore, the body 21 of the center terminal 20 covered by the insulation member 25 does not extend beyond the rear end of the front hole 274. Thus, when the coaxial connector 14 is under the connected state, the contact portion 22 of the center terminal 20 is exposed outward from a front end of the insulation member 25 and extends in the front hole 274 along the center line CL. As a result, the contact portion 22 is completely enclosed by the outer terminal 26, which has a ground potential, in the predetermined plane perpendicular to the center line CL. Moreover, the contact portion 22 located in the front hole 274 extends substantially along the center line CL.

According to the aforementioned arrangement, the contact portion 22 has a predetermined characteristic impedance similar to that of the body 21. According to the present embodiment, difference between the characteristic impedances can be easily reduced. However, the present invention is not limited thereto. For example, the resiliently deformed contact portion 22 does not need to extend along the center line CL, provided that the contact portion 22 is not in contact with an inner wall of the front hole 274.

The resiliently deformed contact portion 22 does not extend completely along the sloping portion 44 of the plate 40. Therefore, a predetermined error angle α is formed between the direction along which the resiliently deformed contact portion 22 extends and the direction along which the sloping portion 44 extends. The intersection angle θ of the center line CL is preferred to be designed within a range of ±α relative to the inclining angle of the sloping portion 44 so that the resiliently deformed contact portion 22 extends substantially along the center line CL.

According to the present embodiment, the contact portion 22 does not extend beyond the front end of the center hole 38. As a result, when the coaxial connector 14 is under the connected sate, the front contact portion 222 of the contact portion 22 which is exposed from the front hole 274 is enclosed by an inner wall of the center hole 38 and the ground layer (not shown) formed on the lower surface 74 of the board 16 in the predetermined plane perpendicular to the center line CL. According to this arrangement, difference between the characteristic impedances can be more reliably reduced. However, the present invention is not limited thereto. For example, the contact portion 22 may extend forward beyond the front end of the center hole 38.

Referring to FIG. 8 together with FIG. 4, according to the present embodiment, difference between the characteristic impedances can be easily reduced by the center hole 38 because the middle projecting portion 34 is provided. However, the present invention is not limited thereto. For example, the middle projecting portion 34 may be provided as necessary.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly comprising a coaxial connector configured to be connected to a board, a plate and a fixing member, wherein:
the board extends along a horizontal plane and has an upper surface in an up-down direction perpendicular to the horizontal plane, the upper surface being formed with a signal line, the signal line extending in a front-rear direction perpendicular to the up-down direction;
the coaxial connector comprises an outer terminal, a center terminal and an insulation member;
the insulation member insulates the outer terminal and the center terminal from each other;
the outer terminal has a projecting portion and an end surface;
the projecting portion projects forward from the end surface and has a pressing portion;
the pressing portion is located at a lower end of the projecting portion;
the center terminal has a contact portion;
the plate has a sloping portion;
the sloping portion is formed on an upper surface of the plate;
the sloping portion extends toward a rear end of the plate while sloping downward;
under a pre-connected state where the coaxial connector is not yet connected to the board, at least a part of the contact portion is located forward of the end surface and is located below the pressing portion;
under a connected state where the coaxial connector is fixed and connected to the board, the fixing member fixes the projecting portion and the plate to each other so that the board is sandwiched and held between the projecting portion and the plate in the up-down direction; and
under the connected state, a front end of the contact portion is located above the sloping portion of the plate and is located at a position which is not beyond a front end of the sloping portion in the front-rear direction, the pressing portion presses the upper surface of the board from above, and at least a part of the contact portion is pressed against the signal line of the board to be in contact with the signal line.

2. The connector assembly as recited in claim 1, wherein:
the outer terminal is formed with an attachment hole;
the center terminal is attached in the attachment hole so as to extend along the front-rear direction;
the attachment hole has a front hole and a rear hole;
the rear hole extends along the front-rear direction; and
the front hole extends forward and upward from a front end of the rear hole and opens forward.

3. The connector assembly as recited in claim 1, wherein:
the projecting portion has two side projecting portions;
the two side projecting portions are apart from each other in a lateral direction perpendicular to both the front-rear direction and the up-down direction;
the two side projecting portions are fixed to the board under the connected state; and
the contact portion is located between the two side projecting portions in the lateral direction.

4. The connector assembly as recited in claim 2, wherein:
the projecting portion has two side projecting portions;
the two side projecting portions are apart from each other in a lateral direction perpendicular to both the front-rear direction and the up-down direction;
the two side projecting portions are fixed to the board under the connected state; and
the contact portion is located between the two side projecting portions in the lateral direction.

5. The connector assembly as recited in claim 1, wherein:
the projecting portion is formed with a screw hole;
the plate is formed with a fixing hole;
the board is formed with a passing hole;
the fixing member is a screw; and
under the connected state, the projecting portion and the board are fixed to each other with a screw which is screwed into the screw hole of the projecting portion through the fixing hole of the plate and the passing hole of the board.

6. The connector assembly as recited in claim 2, wherein:
the projecting portion is formed with a screw hole;
the plate is formed with a fixing hole;
the board is formed with a passing hole;
the fixing member is a screw; and
under the connected state, the projecting portion and the board are fixed to each other with a screw which is screwed into the screw hole of the projecting portion through the fixing hole of the plate and the passing hole of the board.
